(19) United States
(12) Patent Application Publication
(10) Pub. No.: US 2026/0313486 A1
(43) Pub. Date: Oct. 8, 2026

(54) METHOD AND APPARATUS FOR PERFORMING RANDOM ACCESS-LESS HANDOVER IN NTN SYSTEM

(71) Applicant: SAMSUNG ELECTRONICS CO., LTD., Suwon-si, Gyeonggi-do (KR)

(72) Inventors: Sangbum KIM, Suwon-si (KR); Sangyeob JUNG, Suwon-si (KR); Seungri JIN, Suwon-si (KR)

(21) Appl. No.: 19/472,053

(22) PCT Filed: Mar. 29, 2024
(86) PCT No.: PCT/KR2024/004090

§ 371 Date: Oct. 2, 2025

(30) Foreign Application Priority Data
Apr. 5, 2023 (KR) 10-2023-0044889

(51) Int. Cl. H04W 36/00; H04W 36/08

(52) U.S. Cl. CPC H04W 36/00725; H04W 36/083

(57) ABSTRACT

The present disclosure relates to a method and apparatus for performing a random access channel (RACH)-less handover in a non-terrestrial network (NTN), the method and apparatus being for a first NTN base station in a wireless communication system, and comprising the steps of: determining, for a terminal, a RACH-less handover to a second NTN base station; obtaining, from the second NTN base station, configuration information relating to the RACH-less handover; and transmitting, to the terminal, a radio resource control (RRC) reset message comprising the configuration information and timing information applicable to the second NTN base station, wherein whether a timing control value for the second NTN base station is the same as a timing control value for the first NTN base station is indicated by the timing information, and a physical uplink shared channel (PUSCH) transmission from the terminal to the second NTN base station is performed on the basis of the timing information and the configuration information.

### TECHNICAL FIELD

The disclosure relates to a method and apparatus for performing RACH-less handover in an NTN.

### BACKGROUND ART

Fifth generation (5G) mobile communication technology defines a wide frequency band to enable fast transmission speed and new services, and can be implemented not only in a sub-6 GHz frequency band (“sub 6 GHz”) such as 3.5 GHz but also in an ultra-high frequency band (“above 6 GHz”) called mmWave such as 28 GHz or 39 GHz. In addition, 6G mobile communication technology called “beyond 5G system” is being considered for implementation in a terahertz (THz) band (e.g., band of 95 GHz to 3 THz) to achieve transmission speed that is 50 times faster and ultra-low latency that is reduced to 1/10 compared with 5G mobile communication technology.

In the early days of 5G mobile communication technology, to meet service support and performance requirements for enhanced mobile broadband (eMBB), ultra-reliable and low-latency communication (URLLC), and massive machine-type communications (mMTC), standardization has been carried out regarding beamforming for mitigating the pathloss of radio waves and increasing the propagation distance thereof in the mmWave band, massive MIMO, support of various numerology for efficient use of ultra-high frequency resources (e.g., operating multiple subcarrier spacings), dynamic operations on slot formats, initial access schemes to support multi-beam transmission and broadband, definition and operation of bandwidth parts (BWP), new channel coding schemes such as low density parity check (LDPC) codes for large-capacity data transmission and polar codes for reliable transmission of control information, L2 pre-processing, and network slicing for providing a dedicated network specialized for a specific service.

Currently, discussions are underway to improve 5G mobile communication technology and enhance performance thereof in consideration of the services that the 5G mobile communication technology has initially intended to support, and physical layer standardization is in progress for technologies such as V2X (Vehicle-to-Everything) that aims to help a self-driving vehicle to make driving decisions based on its own location and status information transmitted by vehicles and to increase user convenience, new radio unlicensed (NR-U) for the purpose of system operation that meets various regulatory requirements in unlicensed bands, low power consumption scheme for NR terminals (UE power saving), non-terrestrial network (NTN) as direct terminal-satellite communication to secure coverage in an area where communication with a terrestrial network is not possible, and positioning.

In addition, standardization in radio interface architecture/protocol is in progress for technologies such as intelligent factories (industrial Internet of things, IIoT) for new service support through linkage and convergence with other industries, integrated access and backhaul (IAB) that provides nodes for network service area extension by integrating and supporting wireless backhaul links and access links, mobility enhancement including conditional handover and dual active protocol stack (DAPS) handover, 2-step random access (2-step RACH for NR) that simplifies the random access procedure; and standardization in system architecture/service is also in progress for the 5G baseline architecture (e.g., service based architecture, service based interface) for integrating network functions virtualization (NFV) and software defined networking (SDN) technologies, and mobile edge computing (MEC) where the terminal receives a service based on its position.

When such a 5G mobile communication system is commercialized, connected devices whose number is explosively increasing will be connected to the communication networks; accordingly, it is expected that enhancement in function and performance of the 5G mobile communication system and the integrated operation of the connected devices will be required. To this end, new research will be conducted regarding 5G performance improvement and complexity reduction, AI service support, metaverse service support, and drone communication by utilizing extended reality (XR) for efficiently supporting augmented reality (AR), virtual reality (VR), and mixed reality (MR), artificial intelligence (AI), and machine learning (ML).

Further, such advancement of 5G mobile communication systems will be the basis for the development of technologies such as new waveforms for ensuring coverage in the terahertz band of 6G mobile communication technology, full dimensional MIMO (FD-MIMO), multi-antenna transmission such as array antenna or large scale antenna, metamaterial-based lenses and antennas for improved coverage of terahertz band signals, high-dimensional spatial multiplexing using orbital angular momentum (OAM), reconfigurable intelligent surface (RIS) technique, full duplex technique to improve frequency efficiency and system network of 6G mobile communication technology, satellites, AI-based communication that utilizes artificial intelligence (AI) from the design stage and internalizes end-to-end AI support functions to realize system optimization, and next-generation distributed computing that realizes services whose complexity exceeds the limit of terminal computing capabilities by utilizing ultra-high-performance communication and computing resources.

The non-terrestrial network (NTN) is a technology that provides data services to terminals on the ground by utilizing artificial satellites or unmanned aerial systems (UAS) at high altitudes. In NTN, data transmission and reception are supported by utilizing satellites located at high altitudes, so when a terminal performs random access, a long time is required until completion, which may increase the probability of handover failure.

### DISCLOSURE OF INVENTION

### Technical Problem

Accordingly, an object of the disclosure is to propose a method for introducing RACH-less handover to the NTN.

### Solution to Problem

A method performed by a first non-terrestrial network (NTN) base station in a wireless communication system according to one example of the disclosure to solve the above problem may include: determining a random access channel (RACH)-less handover to a second NTN base station for a terminal; obtaining, from the second NTN base station, configuration information associated with the RACH-less handover; and transmitting, to the terminal, a radio resource control (RRC) reconfiguration message including the configuration information and timing information applied to the second NTN base station, wherein whether a timing adjustment value for the second NTN base station is equal to a timing adjustment value for the first NTN base station may be indicated by the timing information, and wherein physical uplink shared channel (PUSCH) transmission from the terminal to the second NTN base station may be performed based on the timing information and the configuration information.

In addition, a method performed by a terminal in a wireless communication system according to one example of the disclosure may include: receiving, from a first non-terrestrial network (NTN) base station, a radio resource control (RRC) reconfiguration message including configuration information associated with a random access channel (RACH)-less handover to a second NTN base station and timing information applied to the second NTN base station; and performing physical uplink shared channel (PUSCH) transmission to the second NTN base station based on the timing information and the configuration information, wherein whether a timing adjustment value for the second NTN base station is equal to a timing adjustment value for the first NTN base station may be indicated by the timing information.

In addition, a first non-terrestrial network (NTN) base station in a wireless communication system according to one example of the disclosure may include: a transceiver; and a controller configured to determine a random access channel (RACH)-less handover to a second NTN base station for a terminal, obtain, from the second NTN base station, configuration information associated with the RACH-less handover, and control the transceiver to transmit, to the terminal, a radio resource control (RRC) reconfiguration message including the configuration information and timing information applied to the second NTN base station, wherein whether a timing adjustment value for the second NTN base station is equal to a timing adjustment value for the first NTN base station may be indicated by the timing information, and wherein physical uplink shared channel (PUSCH) transmission from the terminal to the second NTN base station may be performed based on the timing information and the configuration information.

In addition, a terminal in a wireless communication system according to one example of the disclosure may include: a transceiver; and a controller configured to control the transceiver to receive, from a first non-terrestrial network (NTN) base station, a radio resource control (RRC) reconfiguration message including configuration information associated with a random access channel (RACH)-less handover to a second NTN base station and timing information applied to the second NTN base station, and control the transceiver to perform physical uplink shared channel (PUSCH) transmission to the second NTN base station based on the timing information and the configuration information, wherein whether a timing adjustment value for the second NTN base station is equal to a timing adjustment value for the first NTN base station may be indicated by the timing information.

### Advantageous Effects of Invention

According to an embodiment of the disclosure, by applying appropriate factors that take into account the characteristics of the NTN, such as additional delay occurring in links between ground stations, satellites, and terminals, and coordination required between source cells and target cells, assuming existing random access channel (RACH)-less handover, RACH-less handover can be effectively supported in the NTN.

### BRIEF DESCRIPTION OF DRAWINGS

FIG. 1 is a diagram illustrating the architecture of a next-generation mobile communication system according to an embodiment of the disclosure.

FIG. 2 is a diagram for describing a random access process according to an embodiment of the disclosure.

FIG. 3 is a diagram for describing a non-terrestrial network (NTN) according to an embodiment of the disclosure.

FIG. 4 is a diagram illustrating the format of a timing advance report MAC CE according to an embodiment of the disclosure.

FIG. 5 is a sequence diagram of a process for performing RACH-less handover in a mobile communication system according to an embodiment of the disclosure.

FIG. 6 is a diagram for describing a scenario for performing RACH-less handover in an NTN according to an embodiment of the disclosure.

FIG. 7 is a sequence diagram of a first process for performing NTN RACH-less handover according to an embodiment of the disclosure.

FIG. 8 is a sequence diagram of a second process for performing NTN RACH-less handover according to an embodiment of the disclosure.

FIG. 9 is a sequence diagram of a third process for performing NTN RACH-less handover according to an embodiment of the disclosure.

FIG. 10 is a diagram for describing a scenario supporting CA/DC in an NTN according to an embodiment of the disclosure.

FIG. 11 is a sequence diagram of a fourth process for performing NTN RACH-less handover according to an embodiment of the disclosure.

FIG. 12 is a diagram illustrating the format of a new timing advance report MAC CE according to an embodiment of the disclosure.

FIG. 13 is a flowchart of UE operations for performing NTN RACH-less handover according to an embodiment of the disclosure.

FIG. 14 is a flowchart of base station operations for performing NTN RACH-less handover according to an embodiment of the disclosure.

FIG. 15 is a diagram illustrating a scenario for an intra-NTN satellite to perform RACH-less handover according to an embodiment of the disclosure.

FIG. 16 is a block diagram illustrating the internal structure of a UE according to an embodiment of the disclosure.

FIG. 17 is a block diagram illustrating the structure of a base station according to an embodiment of the disclosure.

### MODE FOR THE INVENTION

In the following description of the disclosure, upon determining that a specific description of a related well-known function or configuration may unnecessarily obscure the subject matter of the disclosure, the detailed description thereof will be omitted. Hereinafter, embodiments of the disclosure will be described with reference to the accompanying drawings. The description of the disclosure is based on the LTE system, but it is also applicable to other mobile communication systems such as NR, which is a next-generation mobile communication system. For example, in the disclosure, ‘eNB’ in LTE corresponds to ‘gNB’ in NR, and ‘MME’ in LTE corresponds to ‘AMF’ in NR.

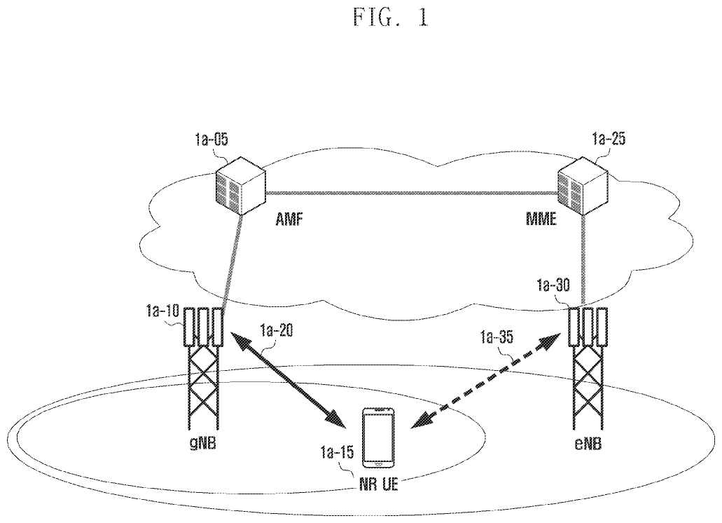

FIG. 1 is a diagram illustrating the architecture of a next-generation mobile communication system according to an embodiment of the disclosure.

With reference to FIG. 1, as shown, the radio access network of the next-generation mobile communication system (New Radio, NR) is composed of a next-generation base station (New Radio node B, referred to as gNB) 1a-10 and an AMF (New Radio core network) 1a-05. A user terminal (New Radio user equipment, referred to as NR UE or terminal) 1a-15 connects to an external network through the gNB 1a-10 and an access and mobility management function (AMF) 1a-05.

In FIG. 1, the gNB corresponds to an evolved node B (eNB) of the existing LTE (long term evolution) system. The gNB may be connected to the NR UE through a radio channel, and it can provide a more superior service than that of the existing node B (1a-20). All user traffic is serviced through shared channels in the next-generation mobile communication system. Hence, there is a need for an entity that performs scheduling by collecting status information, such as buffer states, available transmission power states, and channel states of individual UEs, and the gNB 1a-10 takes charge of this scheduling. Typically, one gNB controls a plurality of cells. To implement ultra-high-speed data transmission compared with existing LTE, a bandwidth beyond the existing maximum bandwidth may be utilized. Also, a beamforming technology may be additionally combined with orthogonal frequency division multiplexing (OFDM) serving as a radio access technology. Further, an adaptive modulation and coding (AMC) scheme determining a modulation scheme and channel coding rate to match the channel state of the UE is applied.

The AMF 1a-05 performs functions such as mobility support, bearer configuration, and quality of service (QoS) configuration. The AMF 1a-05 is an entity taking charge of not only mobility management but also various control functions for the UE, and is connected to a plurality of base stations. In addition, the next-generation mobile communication system may interwork with the existing LTE system, and the AMF is connected to the mobility management entity (MME) 1a-25 through a network interface. The MME is connected to the eNB 1a-30 being an existing base station. A UE supporting LTE-NR dual connectivity may maintain a connection not only to the gNB but also to the eNB to transmit and receive data (1a-35).

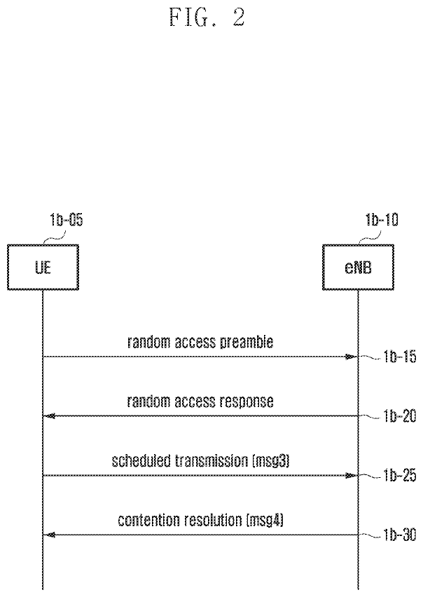

FIG. 2 is a diagram for describing a random access process according to an embodiment of the disclosure.

Random access is performed when uplink synchronization is achieved or when data is transmitted to the network. More specifically, it may be performed when transitioning from idle mode to connected mode, when performing radio resource control (RRC) re-establishment, when performing handover, and when starting uplink or downlink data transmission.

When the UE 1b-05 receives a dedicated preamble from the base station 1b-10, it performs preamble transmission using the dedicated preamble. In contrast, if a dedicated preamble is not provided, the UE selects one of the two preamble groups and selects a preamble belonging to the selected group. The above groups are called group A and group B. The UE selects a preamble belonging to group B if the channel quality state is better than a specific threshold and the size of msg 3 is greater than a specific threshold, otherwise it selects a preamble belonging to group A.

If the above preamble is transmitted at n^{th} subframe (1b-15), the UE 1b-05 starts a random access response (RAR) window from n+3^{th} subframe and monitors whether an RAR is transmitted within the window time interval (1b-20). The RAR scheduling information is indicated by RA-RNTI (random access-radio network temporary identity) of the physical downlink control channel (PDCCH). The RA-RNTI is derived using the time and frequency domain radio resource location having been used to transmit the above preamble. The above RAR includes timing advance, UL grant, and temporary cell (C)-RNTI. The timing advance information is used by the UE to determine timing when transmitting an uplink signal.

If the RAR is successfully received in the RAR window, the UE 1b-05 transmits msg 3 (1b-25) by using the UL grant information included in the RAR. Msg 3 includes different information depending on the purpose of the random access. Table 1 below illustrates information included in msg 3.

TABLE 1
Examples of information included in msg3

| CASE | Message 3 Contents |
|---|---|
| RRC CONNECTION SETUP | CCCH SDU |
| RRC RE-ESTABLISHMENT | CCCH SDU, BSR (if grant is enough), PHR (if triggered & |
| | grant is enough) |
| Handover (random preamble) | C-RNTI CE, BSR, PHR, (part of) DCCH SDU |
| Handover (dedicated preamble) | BSR, PHR, (part of) DCCH SDU |
| UL resume | C-RNTI CE, BSR, PHR, (part of) DCCH/DTCH SDU |
| PDCCH order (random preamble) | C-RNTI CE, BSR, PHR, (part of) DCCH/DTCH SDU |
| PDCCH order (dedicated preamble) | BSR, PHR, (part of) DCCH/DTCH SDU |

If the UE 1b-05 receives the RAR at n^{th} subframe, Msg3 is transmitted at n+6^{th} subframe. Hybrid automatic repeat request (HARQ) is applied from msg 3 onwards. After transmitting msg 3, the UE 1b-05 starts a specific timer and monitors a contention resolution (CR) message until the timer expires (1b-30). The CR message includes, in addition to a CR MAC (medium access control) CE (control element), an RRC connection setup or RRC connection reestablishment message depending on the purpose of random access.

In the base station 1b-10, signals transmitted from multiple UEs should be received with time synchronization so that individual signals can be separated and decoded. Hence, the base station 1b-10 provides timing advance command information to each UE through the random access process or using a timing advance command MAC CE to adjust the synchronization of the uplink signals. Upon receiving the timing advance command information, the UE 1b-05 uses it to adjust the timing for transmitting an uplink signal.

Timing advance time T_TA is derived using the following equation.

T_TA=(N_TA+N_TA,offset)×T_c [Equation 1]

Here, N_TA is the timing advance command information provided by RAR/MSGB or timing advance command MAC CE, N_TA,offset is an offset value, and T_c indicates the sampling time. During the initial random access process, the N_TA value is set to a value of 0.

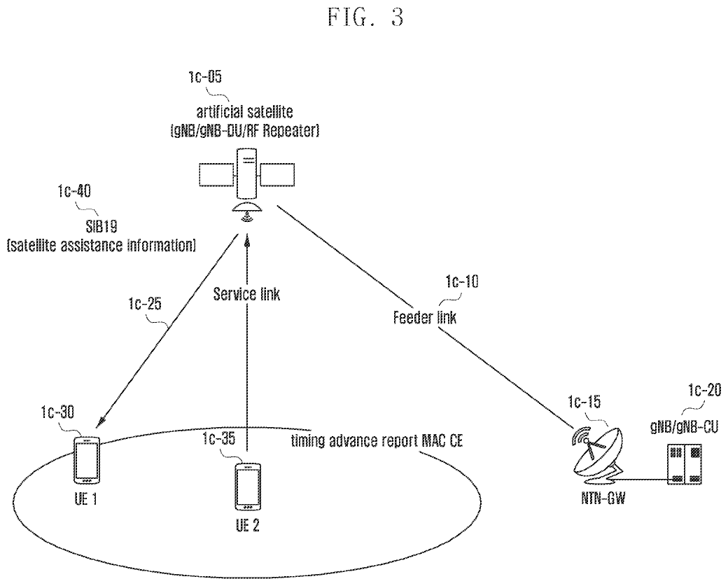

FIG. 3 is a diagram for describing a non-terrestrial network (NTN) according to an embodiment of the disclosure.

The NTN is a technology that provides data services to UEs on the ground by utilizing an artificial satellite or unmanned aerial system (UAS) at high altitudes. The satellite 1c-05 acts as independent gNB, or DU, gNB-DU or RF (radio frequency) repeater in the CU (central unit)-DU (distributed unit) functional split; and depending on the role of the satellite, there is a gNB-CU or gNB 1c-20 connected to the NTN-gateway (GW) 1c-15 on the ground. The wireless section between the satellite 1c-05 and the NTN-GW 1c-15 on the ground is called a feeder link 1c-10, and the wireless section between the satellite 1c-05 and the UE 1c-30 or 1c-35 on the ground is called a service link 1c-25. Since the artificial satellite is moving at a high speed and at a high altitude, a very long propagation delay and Doppler distortion phenomenon occur. Hence, for the artificial satellite and the UE to communicate smoothly, these distortion phenomena should be compensated for in advance. For this, specific information is required, and the artificial satellite 1c-05 provides this information to the UEs 1c-30 and 1c-35 on the ground through system information SIB19 1c-40. SIB19 includes various information necessary to compensate for the propagation delay and Doppler distortion such as information about the location and velocity of the satellite and neighbor satellites. The UEs 1c-30 and 1c-35 compensate for the distortion phenomenon by utilizing the above information together with their own location information.

In communication with the NTN, a very long propagation delay occurs. Hence, the time synchronization as described in Equation 1 is not sufficient to compensate for this delay. For example, the delay time in the feeder link and the delay time in the service link from the long distance between the satellite and the UE are beyond the adjustment range through existing time synchronization schemes. Therefore, the timing advance time T_TA in NTN uses Equation 2 below.

$$T\_TA = ( N\_TA + N\_TA , common + N\_TA , UE - specific + N\_TA , offset ) \times T\_c \qquad [ Equation 2 ]$$

Here, N_TA,common is a value that compensates for the delay time in the feeder link, and the required information (TA-Info IE) to calculate it is provided by SIB19, and the UE derives the value through the specified information and specified equation. The TA-Info IE includes ta-Common, ta-CommonDrift, and ta-CommonDrift Variant, and the definitions of these fields are as shown in Table 2 below (extracted from TS38.331).

TABLE 2
ta-Common
Network-controlled common timing advanced value and it may include any timing offset considered
necessary by the network. ta-Common with value of 0 is supported. The granularity of ta-Common
is 4.072 × 10\hat{ }(−3) μs. Values are given in unit of corresponding granularity. This field is excluded
when determining changes in system information, i.e. changes of ta-Common should neither result
in system information change notifications nor in a modification of valueTag in SIB1.
ta-CommonDrift
Indicate drift rate of the common TA. The granularity of ta-CommonDrift is 0.2 × 10\hat{ }(−3) μs/s
Values are given in unit of corresponding granularity. This field is excluded when determining
changes in system information, i.e. changes of ta-CommonDrift should neither result in system
information change notifications nor in a modification of valueTag in SIB1.
ta-CommonDriftVariant
Indicate drift rate variation of the common TA. The granularity of ta-CommonDriftVariation is
0.2 × 10\hat{ }(−4) μs/s\hat{ }2. Values are given in unit of corresponding granularity. This field is excluded
when determining changes in system information, i.e. changes of ta-CommonDriftVariant should
neither result in system information change notifications nor in a modification of valueTag in SIB1.

N_{TA, UE-specific} is a value that compensates for the delay time in the service link. Satellite location information is provided through SIB19, and the UE uses this information together with its own location information to calculate the distance between the satellite and the UE, thereby deriving the above value.

In the disclosure, T_{TA, common} and T_{TA, UE-specific} represent the feeder link propagation delay time and service link propagation delay time, respectively. These values are derived by multiplying N_{TA, common} and N_{TA, UE-specific} by Tc.

The T_{TA} value is useful for the NTN cell to schedule the UE. So, the UE may report a timing advance report MAC CE (TAR MAC CE) including the T_{TA} value to the NTN cell according to the gNB settings. The conditions under which the UE should report the TAR MAC CE are as follows.
At the time of RRC setup, RRC resume, RRC re-establishment (RRE), or handover
When receiving TAR-Config transmitted from the base station
When the difference between the TA value stored in the recently reported TAR MAC CE and the current TA value exceeds a preset threshold

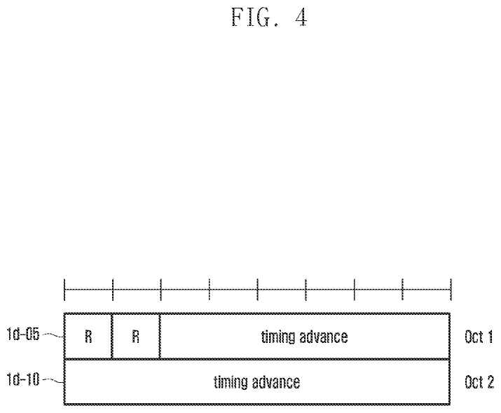

FIG. 4 is a diagram illustrating the format of a timing advance report MAC CE according to an embodiment of the disclosure.

The timing advance report MAC CE is 2 bytes in size and is composed of 2-bit reserved fields 1d-05 and a 14-bit timing advance (TA) field 1d-10. The timing advance field includes the T_{TA} value of the serving NTN cell.

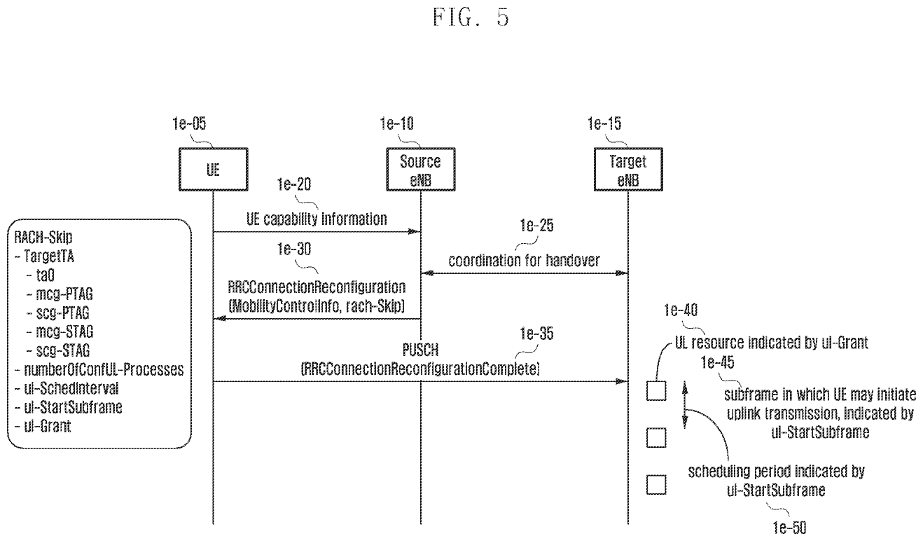

FIG. 5 is a sequence diagram of a process for performing RACH-less handover in a mobile communication system according to an embodiment of the disclosure.

In the LTE system, random access channel (RACH)-less handover has been introduced, which performs handover without random access when the timing advance of the target cell is clearly identified.

More specifically, to perform RACH-less handover, the UE 1e-05 reports its capability information (UE capability information) to the source base station 1e-10 (1e-20). This capability information may include an indicator indicating whether the UE 1e-05 supports RACH-less handover. In LTE, the above indicator corresponds to rach-Less-r14 extracted from the TS36.331 standard document, as shown in Table 3 below.

TABLE 3

| | | |
|---|---|---|
| [symbol] | [symbol] | |
| [symbol] | [symbol] | [symbol] |
| [symbol] | [symbol] | [symbol] |
| [symbol] | | |

[symbol]

indicates data missing or illegible when filed

When determining to perform RACH-less handover for the UE 1e-05, the source base station 1e-10 exchanges necessary configuration information with the neighbor target base station 1e-15 through handover coordination (1e-25). At this time, the target base station 1e-15 may provide the source base station 1e-10 with timing advance information (i.e., timing adjustment indication, for example, N_{TA} value) and uplink scheduling information (ul-ConfigInfo), which are to be applied by the UE when transmitting a signal to the target cell. Here, the uplink scheduling information may be not provided.

Based on the information provided from the target base station 1e-15, the source base station 1e-10 transmits a MobilityControlInfo IE containing specific RACH-less configuration information to the UE 1e-05 (1e-30). The specific RACH-less configuration information corresponds to RACH-Skip-r14 extracted from the TS36.331 standard document as shown in Table 4 below.

TABLE 4

| | | |
|---|---|---|
| [symbol] | [symbol] | |
| [symbol] | [symbol] | |
| [symbol] | [symbol] | |
| [symbol] | [symbol] | |
| [symbol] | [symbol] | |
| [symbol] | [symbol] | |
| [symbol] | [symbol] | |
| [symbol] | | |
| [symbol] | [symbol] | |
| [symbol] | [symbol] | |
| [symbol] | [symbol] | |
| [symbol] | [symbol] | |
| [symbol] | [symbol] | |
| [symbol] | | [symbol] |
| [symbol] | | |

[symbol]

indicates data missing or illegible when filed

The targetTA information corresponds to the timing adjustment indication, where if ta0 is indicated as the targetTA value, it means that N_{TA} is 0; mcg-PTAG means N_{TA} applied to the PTAG (primary timing advance group) in the MCG (master cell group); seg-PTAG means N_{TA} applied to the PTAG in the SCG (secondary cell group); mcg-STAG with STAG-Id means N_{TA} applied to the STAG (secondary timing advance group) corresponding to STAG-Id in the MCG; seg-STAG with STAG-Id means N_{TA} applied to the STAG corresponding to STAG-Id in the SCG. The UE 1e-05 uses the set N_{TA} value to derive the TA value to be applied to transmitting a signal to the target cell. Hence, the target cell for RACH-less handover is limited to a cell that can apply 0 as the N_{TA} value, or a serving cell in the existing CA (carrier aggregation)/DC (dual connectivity) or a cell with the same TA. That is, the target cell is limited to a cell that can apply the N_{TA} value that the UE is already aware of.

numberOfConfUL-Processes information indicates the number of HARQ processes to be applied by the UE 1e-05 in the target cell in correspondence to the uplink grant. ul-SchedInterval information indicates the period of uplink scheduling to be applied by the UE 1e-05 in the target cell (1e-50).

ul-StartSubframe information indicates the subframe at which the UE 1e-05 may perform uplink transmission in the target cell (1e-45). A value of 0 indicates the subframe corresponding to subframe number 0, and a value of 1 indicates the subframe corresponding to subframe number 1.

ul-Grant information refers to a radio resource that enables the UE 1e-05 to perform uplink transmission in the target cell (1e-40).

The target cell 1e-15 allocates radio resources to the UE 1e-05 at the scheduling time derived through the RACH-less configuration information.

The UE 1e-05 having received the RACH-less configuration information transmits a physical uplink shared channel (PUSCH) including an RRCConnectionReconfigurationComplete message to the target cell at a transmission timing derived through the above configuration information (1e-35).

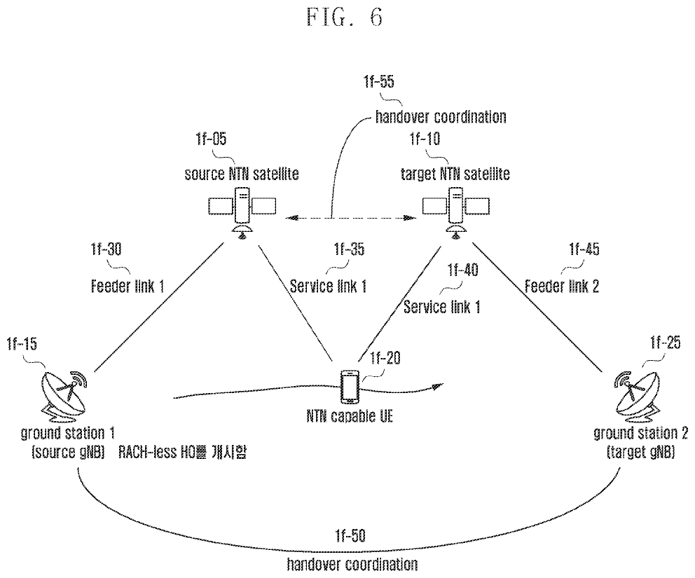

FIG. 6 is a diagram for describing a scenario for performing RACH-less handover in an NTN according to an embodiment of the disclosure.

Since the NTN utilizes satellites located at high altitudes for data transmission and reception, the UE needs a long time to perform random access and complete it. During handover, the UE should perform random access to the target cell, and the long time required for the random access process may increase the failure probability of the handover. Therefore, if RACH-less handover is introduced to the NTN, the above problem can be solved.

However, there are several problems in directly applying RACH-less handover introduced to existing LTE.

First, in NTN, there are a feeder link 1f-30 or 1f-45 between the ground station 1f-15 or 1f-25 and the satellite 1f-05 or 1f-10, and a service link 1f-35 or 1f-40 between the satellite 1f-05 or 1f-10 and the UE 1f-20, and additional delay occurs in each link. Hence, to perform RACH-less handover in NTN, additional factors, namely N_{TA, common}, N_{TA, UE-specific}, should be considered in deriving the timing advance value, unlike existing terrestrial-oriented LTE.

Second, the Rel-17 NTN does not support carrier aggregation (CA)/dual connectivity (DC). Hence, it is possible to restrict that RACH-less handover can be configured only when the NTN supports CA/DC and the target cell is one of the serving cells in CA/DC. If RACH-less handover is configured regardless of the above restriction, RACH-less configuration information different from that of LTE may be required. To perform RACH-less handover, specific coordination is required for exchanging configuration information necessary for RACH-less handover between the source cell and the target cell. In this embodiment, it is assumed that such coordination (1f-50 and 1f-55) is performed through the interface between the source ground station 1f-15 and the target ground station 1f-25 or the interface between the source NTN satellite 1f-05 and the target NTN satellite 1f-10.

Next, in this embodiment, a method for performing RACH-less handover in NTN is proposed.

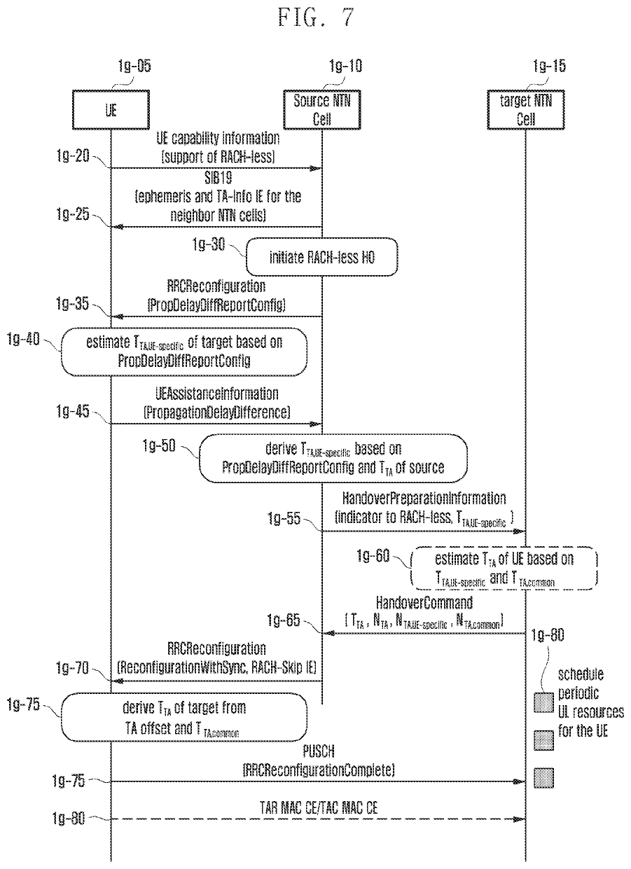

FIG. 7 is a sequence diagram of a first process for performing NTN RACH-less handover according to an embodiment of the disclosure.

The UE 1g-05 transmits its UE capability information to the source NTN base station 1g-10 (1g-20). This capability information includes an indicator indicating whether the UE 1g-05 supports RACH-less handover in the NTN environment.

The source NTN base station 1g-10 broadcasts specific information about the source NTN base station 1g-10 and neighbor NTN cells through system information SIB19 (1g-25). The specific information includes the location (ephemeris) of NTN satellites and information required to derive N_{TA,common} (ta-Common, ta-CommonDrift, ta-CommonDrift Variant).

The source NTN base station 1g-10 determines to initiate RACH-less handover for the UE 1g-05 (1g-30). The source NTN base station 1g-10 transmits PropDelayDiffReportConfig configuration information to the UE 1g-05 via an RRCReconfiguration message (1g-35). This means that the UE reports configured TA information about the neighbor NTN cells at a preset time. This configuration information includes a threshold value threshPropDelayDiff and ephemeris information of neighbor NTN cells neighCellInfoList. neighCellInfoList includes the target NTN cell.

Upon receiving the above configuration information, the UE 1g-05 derives the service link propagation delay (T_{TA, UE-specific}) of a neighbor NTN cell by using ephemeris information of pre-configured neighbor NTN cells (1g-40); and the UE 1g-05 includes the PropagationDelayDifference value (in ms), which is the difference between the service link propagation delay of the serving cell and the service link propagation delay of the neighbor NTN cell, in UEAssistanceInformation (UAI) and transmits it to the source NTN base station 1g-10 (1g-45).

When receiving the above configuration information, if the difference between the recently reported TA value and the current TA value becomes greater than the threshPropDelayDiff value, the UE 1g-05 transmits a UAI message including the current PropagationDelayDifference value to the source NTN base station 1g-10.

In this embodiment, it is proposed that the UE 1g-05 reports the PropagationDelayDifference value to the base station if a specific condition is satisfied. The above specific condition may mean reporting the PropagationDelayDifference value periodically or satisfying the preset condition(s) among the following conditions.
CondEvent A3: Conditional reconfiguration candidate becomes amount of offset better than PCell/PSCell;
CondEvent A4: Conditional reconfiguration candidate becomes better than absolute threshold;
CondEvent A5: PCell/PSCell becomes worse than absolute threshold1 AND Conditional reconfiguration candidate becomes better than another absolute threshold2;
CondEvent D1: Distance between UE and a reference location referenceLocation1 becomes larger than configured threshold distance ThreshFromReference1 and distance between UE and a reference location referenceLocation2 of conditional reconfiguration candidate becomes shorter than configured threshold distance ThreshFromReference2;
CondEvent T1: Time measured at UE becomes more than configured threshold t1−Threshold but is less than t1−Threshold+duration;

The above conditions are conditions introduced in related-art conditional handover, and may be reused as conditions for reporting the PropagationDelay Difference value. The specific description of each condition is in accordance with TS38.331. However, the above conditions are conditions for reporting the PropagationDelayDifference value, and are provided to the UE through separate configuration information different from related-art conditional handover. The base station may configure one or more conditions to the UE; and if at least one or all of the preset conditions is satisfied, the UE reports the most recent PropagationDelayDifference value to the base station. In addition to the conditions described above, new conditions based on signal strength or quality may be introduced to indicate the point in time of handover.

Upon receiving the PropagationDelay Difference value, the source NTN base station 1g-10 derives the service link propagation delay in the target NTN cell 1g-15 based on its service link propagation delay and the received PropagationDelayDifference value of the target NTN cell 1g-15; and the source NTN base station 1g-10 includes the derived value in a HandoverPreparationInformation message and transmits it to the target NTN cell 1g-15 (1g-55). This message is used when making a handover request to the target cell, and may include an indicator indicating that the handover is for a RACH-less handover.

The target NTN cell 1g-15 having received the HandoverPreparationInformation message may recognize the T_{TA,UE-specific} value (i.e., service link propagation delay) for the UE 1g-05 and may directly derive the feeder link propagation delay (T_{TA, common}). Also, the target NTN cell 1g-15 derives the timing advance (T_{TA}) value for the UE 1g-05 based on the T_{TA,UE-specific} and T_{TA, common} values (1g-60). At this time, the target NTN cell 1g-15 may finally determine whether to perform RACH-less handover.

The target NTN cell 1g-15 transmits a HandoverCommand message to the source NTN base station 1g-10 (1g-65). This message may include derived T_{TA} (or N_{TA} for the UE 1g-05 and target NTN cell 1g-15), T_{TA, UE-specific} (or N_{TA,UE-specific}), T_{TA, common} (or N_{TA,common}), and scheduling information (UL grant).

Upon receiving the above message, the source NTN base station 1g-10 transmits an RRCReconfiguration message including handover configuration information to the UE 1g-05 (1g-70). This handover configuration information may include specific information necessary for performing RACH-less handover. The specific information includes information required to derive the timing advance value to be applied when transmitting a PUSCH to the target NTN cell, and scheduling information in the target NTN cell. The information required to derive the timing advance value to be applied when transmitting a PUSCH to the target NTN cell is as follows.
Timing offset value compared to the timing advance value applied to the source NTN cell.

That is, by adding the timing offset value to the timing advance value applied to the source NTN cell, the timing advance value applied to the target NTN cell is derived.
Location information (ephemeris) of target NTN cell

That is, the ephemeris information may be used to derive the service link propagation delay as to the target NTN cell.
TA-Info IE information for the target NTN cell

That is, the above information may be used to derive the feeder link propagation delay as to the target NTN cell.

Upon receiving the above configuration information, the UE 1g-05 derives the timing advance value (T_{TA}) to be applied when transmitting a PUSCH to the target NTN cell 1g-15 based on the received information (1g-75). Alternatively, the UB 1g-05 may derive the timing advance value to be applied when transmitting a PUSCH to the target NTN cell 1g-15 by utilizing the PropagationDelayDifference value most recently derived and transmitted to the source NTN base station 1g-10. Hence, the UE 1g-05 and the target NTN cell 1g-15 derive and have the same timing advance value.

The target NTN cell 1g-15 periodically allocates radio resources to the UE 1g-05 according to the preset scheduling information, taking into account the TA value derived above (1g-80). If the above scheduling information is not provided, the UE 1g-05 monitors the physical downlink control channel (PDCCH) of the target cell.

The UE 1g-05 transmits a PUSCH at a specific time and radio resource location based on the derived TA value and the scheduling information in the target NTN cell 1g-15 (1g-85). The PUSCH includes an RRCReconfigurationComplete message. Upon successfully receiving the PUSCH, to set more accurate uplink timing, the target NTN cell 1g-15 may receive a TAR MAC CE or TAC (timing advance command) MAC CE from the UE 1g-05 (1g-90). If the UE 1g-05 fails to successfully transmit a PUSCH including an RRCReconfigurationComplete message for a preset period of time after receiving the configuration information for the RACH-less handover, the RACH-less handover is considered to have failed, and the UE 1g-05 may perform a re-establishment operation or perform a normal handover involving a random access process to the target cell again. If the RACH-less handover has failed, the UE 1g-05 may store an indicator indicating that the RACH-less handover has failed in the content of a radio link failure (RLF) report, and may report the RLF report to the base station later in the connected mode.

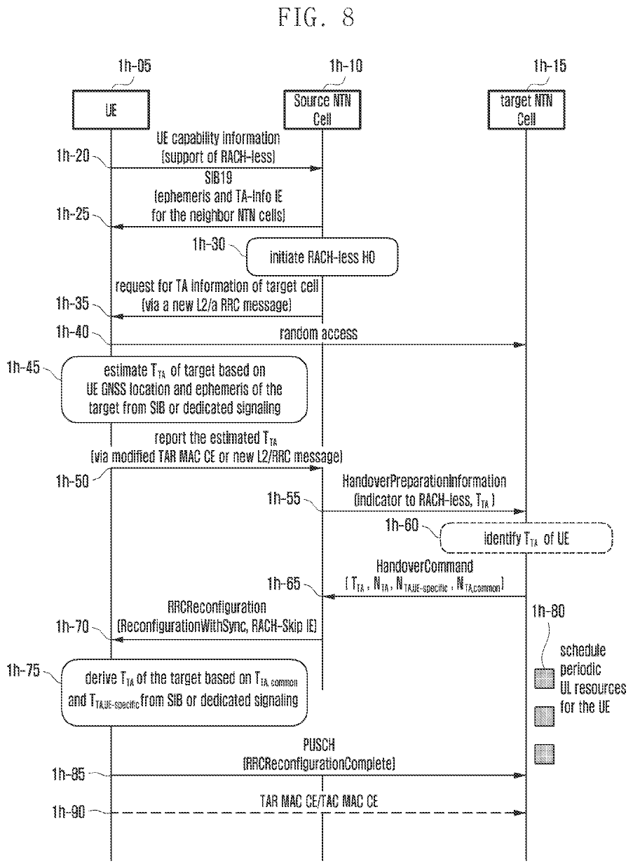

FIG. 8 is a sequence diagram of a second process for performing NTN RACH-less handover according to an embodiment of the disclosure.

The UE 1h-05 transmits its UE capability information to the source NTN base station 1h-10 (1h-20). This capability information includes an indicator indicating whether the UE supports RACH-less handover in the NTN environment.

The source NTN base station 1h-10 broadcasts specific information about it and neighbor NTN cells through system information SIB19 (1h-25). The specific information includes the location (ephemeris) of NTN satellites and information required to derive N_{TA,common} (ta-Common, ta-CommonDrift, ta-CommonDrift Variant). The source NTN base station 1h-10 determines to initiate RACH-less handover for the UE 1h-05 (1h-30).

The source NTN base station 1h-10 makes a request for TA information of the target NTN cell 1h-15 to the UE 1h-05 by using specific L2 signaling or RRC message (1h-35). This L2 signaling or RRC message may include ID information, absolute radio frequency channel number (ARFCN) information (frequency), location information (ephemeris), or TA-Info of the target NTN cell 1h-15.

The UE 1h-05 performs random access to the target NTN cell 1h-15 for the purpose of deriving TA information (1h-40). This random access may be either contention-based random access (CBRA) or contention-free random access (CFRA). In the case of CFRA, prior coordination may be required to determine radio RACH resources dedicated to RACH-less handover between the source base station and the target base station, and the source base station 1h-10 provides the CFRA configuration information to the UE 1h-05 through system information or dedicated signaling.

The UE 1h-05 derives the TA value of the target NTN cell 1h-15 in consideration of the ephemeris information and TA-Info of the target NTN cell 1h-15, and the TAC MAC CE value provided from the target NTN cell 1h-15 (1h-45). Since N_{TA, common} (or T_{TA, common}) for the target NTN cell 1h-15 may be derived by the target NTN cell 1h-15 itself, the UE 1h-05 may derive only the N_{TA} and N_{TA, UE-specific} values.

The UE 1h-05 transmits the derived TA value (or N_{TA} and N_{TA,UE-specific} values) to the source NTN base station 1h-10 by utilizing a TAR MAC CE or specific RRC message (1h-50).

Upon receiving the above information, the source NTN base station 1h-10 includes it in a HandoverPreparationInformation message and transmits the same to the target NTN cell 1h-10 (1h-55). This message is used when requesting a handover to the target cell, and the message may include an indicator indicating that the handover is for RACH-less handover.

The target NTN cell 1h-15 having received the HandoverPreparationInformation message becomes aware of the TA value for the UE 1h-05 (1h-60). The feeder link propagation delay (T_{TA, common}) may be derived directly by the target NTN cell 1h-15. At this time, the target NTN cell 1h-15 may finally determine whether to perform RACH-less handover.

The target NTN cell 1h-15 transmits a HandoverCommand message to the source NTN base station 1h-10 (1h-65). This message may include derived T_{TA} (or N_{TA} for UE 1h-05 and target NTN cell 1h-15), T_{TA, UE-specific} (or N_{TA,UE-specific}), T_{TA,common} (or N_{TA,common}), and scheduling information (UL grant).

Upon receiving the above message, the source NTN base station 1h-10 transmits an RRCReconfiguration message including handover configuration information to the UE 1h-05 (1h-70). This handover configuration information may include specific information necessary for performing RACH-less handover. The specific information includes information required to derive the timing advance value to be applied when transmitting a PUSCH to the target NTN cell 1h-15, and scheduling information in the target NTN cell 1h-15. The information required to derive the timing advance value to be applied when transmitting a PUSCH to the target NTN cell 1h-15 is as follows.
Timing advance value applied to the target NIN cell, N_{TA,UE-specific} (or T_{TA, UE-specific}), N_{TA, common} (or T_{TA,common})
Timing offset value compared to the timing advance value applied to the source NTN cell.

That is, by adding the timing offset value to the timing advance value applied to the source NTN cell, the timing advance value applied to the target NTN cell is derived.
Location information (ephemeris) of target NTN cell

That is, the ephemeris information may be used to derive the service link propagation delay as to the target NTN cell.
TA-Info IE information for the target NTN cell

That is, the above information may be used to derive the feeder link propagation delay as to the target NTN cell.

Upon receiving the above configuration information, the UE 1h-05 derives the timing advance value (T_{TA}) to be applied when transmitting a PUSCH to the target NTN cell 1h-15 based on the received information (1h-75). Hence, the UE 1h-05 and the target NTN cell 1h-15 derive and have the same timing advance value.

The target NTN cell 1h-15 periodically allocates radio resources to the UE 1h-05 according to the preset scheduling information, taking into account the TA value derived above (1h-80). If the above scheduling information is not provided, the UE 1h-05 monitors the PDCCH of the target cell. The UE 1h-05 transmits a PUSCH at a specific time and radio resource location based on the derived TA value and the scheduling information in the target NTN cell 1h-15 (1h-85). The PUSCH includes an RRCReconfigurationComplete message.

Upon successfully receiving the PUSCH, to set more accurate uplink timing, the target NTN cell 1h-15 may receive a TAR MAC CE or TAC (timing advance command) MAC CE from the UE 1h-05 (1h-90).

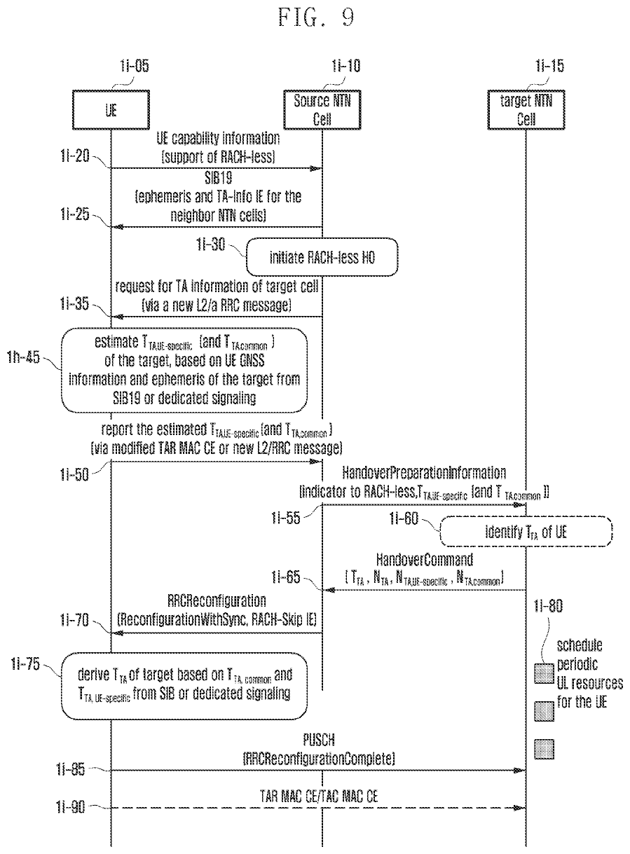

FIG. 9 is a sequence diagram of a third process for performing NTN RACH-less handover according to an embodiment of the disclosure.

The UE 1i-05 transmits its UE capability information to the source NTN base station 1i-10 (1i-20). This capability information includes an indicator indicating whether the UE supports RACH-less handover in the NTN environment.

The source NTN base station 1i-10 broadcasts specific information about the source NTN base station 1i-10 and neighbor NTN cells through system information SIB19 (1i-25). The specific information includes the location (ephemeris) of NTN satellites and information required to derive N_{TA,common} (ta-Common, ta-CommonDrift, ta-CommonDrift Variant).

The source NTN base station 1i-10 determines to initiate RACH-less handover for the UE 1i-05 (1i-30).

The source NTN base station 1i-10 makes a request for the TA information of the target NTN cell 1i-15 to the UE 1i-05 by using specific L2 signaling or RRC message (e.g., RRCReconfiguration) (1i-35). The above L2 signaling or RRC message may include the ID information, reporting conditions, ARFCN information (frequency), location information (ephemeris), or TA-Info of the target NTN cell 1i-15.

In this embodiment, it is proposed that the UE 1i-05 reports specific TA information of a neighbor target cell to the base station if a specific condition is satisfied. The specific condition may mean periodically reporting the timing advance value of a neighbor target cell or satisfying preset condition(s) among the following conditions.
CondEvent A3: Conditional reconfiguration candidate becomes amount of offset better than PCell/PSCell;
CondEvent A4: Conditional reconfiguration candidate becomes better than absolute threshold;
CondEvent A5: PCell/PSCell becomes worse than absolute threshold1 AND Conditional reconfiguration candidate becomes better than another absolute threshold2;
CondEvent D1: Distance between UE and a reference location referenceLocation1 becomes larger than configured threshold distance ThreshFromReference1 and distance between UE and a reference location referenceLocation2 of conditional reconfiguration candidate becomes shorter than configured threshold distance Thresh FromReference2;
CondEvent T1: Time measured at UE becomes more than configured threshold t1−Threshold but is less than t1−Threshold+duration;

The above conditions are conditions introduced in related-art conditional handover, and may be reused as conditions for reporting the timing advance value. The specific description of each condition is in accordance with TS38.331. However, the above conditions are conditions for reporting the timing advance value, and are provided to the UE through separate configuration information different from related-art conditional handover. The base station may configure one or more conditions to the UE; and if at least one or all of the preset conditions is satisfied, the UE reports the most recent timing advance value to the base station by using a TAR MAC CE or specific RRC message (e.g., MeasurementReport message). Here, the TAR MAC CE may be improved to be able to report the TA value of a neighbor target cell other than the serving cell. For example, the TAR MAC CE may additionally include ID information or cell index information of the neighbor target cell. Alternatively, it may be distinguished from a legacy TAR MAC CE by using a new LCID (logical channel ID). In addition to the conditions described above, new conditions based on signal strength or quality may be introduced to indicate the point in time of handover.

The UE 1i-05 derives the TA value of the target NTN cell 1i-15, N_{TA,UE-specific} value (or T_{TA,specific}) Or N_{TA,common} (or T_{TA, common}) in consideration of the ephemeris information and TA-Info of the target NTN cell (1i-45). Since N_{TA,common} (or T_{TA,common}) for the target NTN cell 1i-15 may be derived directly by the target NTN cell, the UE 1i-05 may derive only the N_{TA,UE-specific} value (or T_{TA,specific}). The UE 1i-05 transmits the derived N_{TA,UE-specific} value (or T_{TA,specific}) or N_{TA,common} value (or T_{TA,common}) to the source NTN base station 1i-10 by using a TAR MAC CE or specific RRC message (1i-50).

The source NTN base station 1i-10 includes the information obtained from the UE 1i-05 in a HandoverPreparationInformation message and transmits it to the target NTN cell 1i-15 (1i-55). This message is used when making a handover request to the target cell, and the message may include an indicator indicating that the handover is for RACH-less handover.

The target NTN cell 1i-15 having received the HandoverPreparationInformation message may recognize the T_{TA,UE-specific} value for the UE 1i-05 and may directly derive the feeder link propagation delay (T_{TA,common}). The target NTN cell 1i-15 derives the timing advance (T_{TA}) value for the UE 1i-05 based on the T_{TA, UE-specific} and T_{TA, common} values (1i-60). At this time, the target NTN cell 1i-15 may finally determine whether to perform RACH-less handover.

The target NTN cell 1i-15 transmits a HandoverCommand message to the source NTN base station 1i-10 (1i-65). This message may include derived T_{TA} (or N_{TA} for the UE 1i-05 and target NTN cell 1i-15), T_{TA,UE-specific} (or N_{TA, UE-specific}), T_{TA, common} (or N_{TA,common}), and scheduling information (UL grant).

Upon receiving the above message, the source NTN base station 1i-10 transmits an RRCReconfiguration message including handover configuration information to the UE 1i-05 (1i-70). This handover configuration information may include specific information necessary for performing RACH-less handover. The specific information includes information required to derive the timing advance value to be applied when transmitting a PUSCH to the target NTN cell, and scheduling information in the target NTN cell. The information required to derive the timing advance value to be applied when transmitting a PUSCH to the target NTN cell is as follows.
Timing advance value applied to the target NTN cell, N_{TA,UE-specific} (or T_{TA,UE-specific}), N_{TA, common} (or T_{TA,common})
Timing offset value compared to the timing advance value applied to the source NTN cell.

That is, by adding the timing offset value to the timing advance value applied to the source NTN cell, the timing advance value applied to the target NTN cell is derived.
Location information (ephemeris) of target NTN cell

That is, the ephemeris information may be used to derive the service link propagation delay as to the target NTN cell.
TA-Info IE information for the target NTN cell

That is, the above information may be used to derive the feeder link propagation delay as to the target NTN cell.

Upon receiving the above configuration information, the UE 1i-05 derives the timing advance value (T_{TA}) to be applied when transmitting a PUSCH to the target NTN cell 1i-15 based on the received information (1i-75). Alternatively, the UE 1i-05 may derive the timing advance value to be applied when transmitting a PUSCH to the target NTN cell 1i-15 by utilizing the TA value (e.g., T_{TA}, T_{TA,UE-specific} or N_{TA,UE-specific}) most recently derived and transmitted to the source NTN base station 1i-10. Hence, the UE 1i-05 and the target NTN cell 1i-15 derive and have the same timing advance value.

The target NTN cell 1i-15 periodically allocates radio resources to the UE 1i-05 according to the preset scheduling information, taking into account the TA value derived above (1i-80). If the above scheduling information is not provided, the UE 1i-05 monitors the PDCCH of the target cell. The UE 1i-05 transmits a PUSCH at a specific time and radio resource location based on the derived TA value and the scheduling information in the target NTN cell (1i-85). The PUSCH includes an RRCReconfigurationComplete message.

Upon successfully receiving the PUSCH, to set more accurate uplink timing, the target NTN cell 1i-15 may receive a TAR MAC CE or TAC (timing advance command) MAC CE from the UE 1i-05 (1i-90).

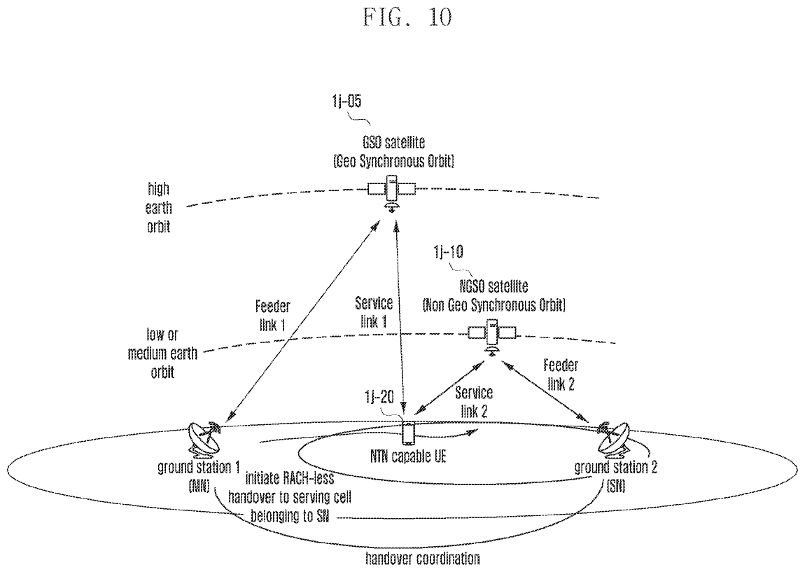

FIG. 10 is a diagram for describing a scenario supporting CA/DC in an NTN according to an embodiment of the disclosure.

The NTN uses satellites located at high altitudes for data transmission and reception, and satellites are classified into high-altitude geosynchronous satellites 1j-05 and low-orbit satellites 1j-10 according to the altitude. The speed of a geosynchronous satellite is the same as the speed of the Earth's rotation, so it appears to be fixed at a certain altitude when viewed from the ground. On the other hand, a low-orbit satellite is greatly affected by the Earth's gravity, so it must travel at a much faster speed than a geosynchronous satellite to maintain its altitude relative to the Earth. Hence, a low-orbit satellite usually appears to be moving at a certain altitude when viewed from the ground because it is moving faster than the Earth's rotation.

In Rel-18 NTN, a method of providing data transmission and reception services to UEs by considering both geosynchronous satellites and low-orbit satellites is being discussed. For example, geosynchronous satellites are advantageous in providing a wide service area because they are located at a relatively high altitude; and low-orbit satellites provide a narrow service area compared to geosynchronous satellites due to their low altitude, but are advantageous in terms of delay and reception signal strength compared to geosynchronous satellites because of their low altitude relative to the ground. Therefore, a geosynchronous satellite may be configured as the master node (MN) to support stable mobility, and a low-orbit satellite may be configured as a secondary node (SN) to improve service quality, which may provide dual connectivity to the UE 1j-20. If CA or DC is introduced to the NTN as described above, when considering RACH-less handover in the NTN, the target cell may be one serving cell in CA/DC, and in this case, TA-related configuration information may be provided similarly to the case of LTE.

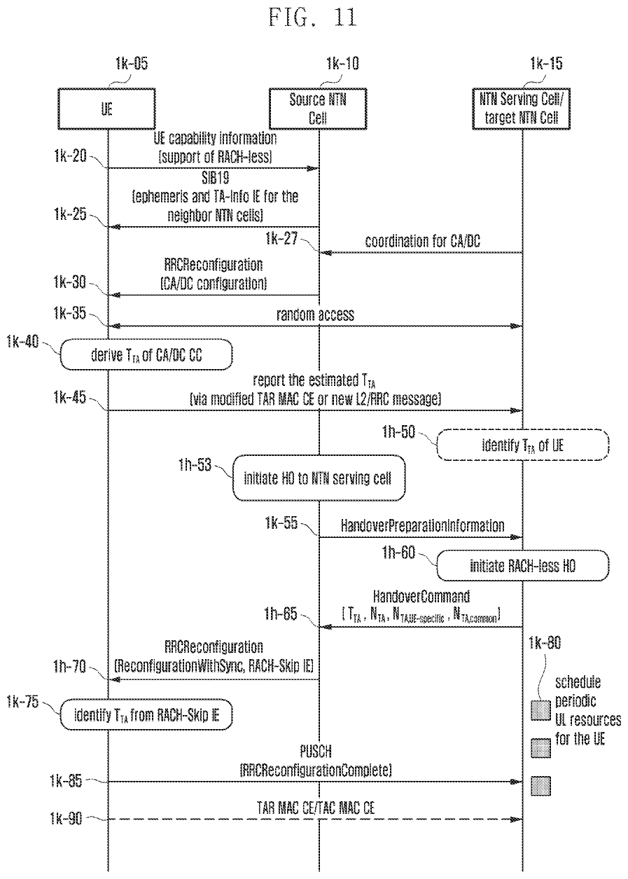

FIG. 11 is a sequence diagram of a fourth process for performing NTN RACH-less handover according to an embodiment of the disclosure.

The UE 1k-05 transmits its UE capability information to the source NTN base station 1k-10 (1k-20). This capability information includes an indicator indicating whether the UE supports RACH-less handover in the NTN environment.

The source NTN base station 1k-10 broadcasts specific information about it and neighbor NTN cells through system information SIB19 (1k-25). The specific information includes the location (ephemeris) of NTN satellites and information required to derive N_{TA, common} (ta-Common, ta-CommonDrift, ta-CommonDrift Variant). To configure carrier aggregation (CA) or dual connectivity (DC) to the UE 1k-05, the source NTN base station 1k-10 exchanges related configuration information with specific neighbor NTN cells 1h-15 (1k-27). The source NTN base station 1k-10 uses an RRCReconfiguration message to configure the neighbor NTN cell 1k-15 as a serving cell for the UE 1k-05 (1h-35). At this time, a corresponding TAG ID may be set together to indicate which TAG (timing advance group) the serving cell belongs to.

The UE 1k-05 performs random access to the neighbor NTN cell 1k-15 for the purpose of deriving TA information (1k-35).

The UE 1k-05 derives the TA value of the neighbor NTN cell 1k-15 in consideration of the ephemeris information and TA-Info of the target NTN cell 1k-15, and the TAC MAC CE value provided from the target NTN cell 1k-15 (1k-40).

The UE 1k-05 transmits the derived TA value to the source NTN base station 1k-10 by using a TAR MAC CE or specific RRC message (1k-45). Here, the TAR MAC CE may include a corresponding TAG ID or specific indicator information (ID field) indicating the neighbor NTN cell. TAR MAC CE and propagationDelayDifference reporting enhanced for the purpose of supporting CA or DC in NTN is described below.

The target NTN cell 1k-15 having received the TAR MAC CE or specific RRC message recognizes the TA value for the UE 1k-05 (1k-50). The NTN serving cell performs scheduling for the UE 1k-05 in consideration of the above TA.

The source NTN base station 1k-10 determines to hand over the UE 1k-05 to the NTN serving cell in the CA or DC state (1k-53). Then, the source NTN base station 1k-10 transmits this to the target NTN cell 1k-15 through a HandoverPreparationInformation message (1k-55). This message is used to make a handover request to the target cell. The target NTN cell 1k-15 having received the HandoverPreparationInformation message determines whether to perform RACH-less handover, and transmits a HandoverCommand message to the source NTN base station 1k-10 (1k-65). Here, this message includes TA information and scheduling information (UL grant), which means that the UE 1k-05 should perform RACH-less handover.

Upon receiving the above message, the source NTN base station 1k-10 transmits an RRCReconfiguration message including handover configuration information to the UE 1k-05 (1k-70). This handover configuration information may include specific information necessary for performing RACH-less handover. The specific information includes information required to derive the timing advance value to be applied when transmitting a PUSCH to the target NTN cell, and scheduling information in the target NTN cell. The targetTA information required to derive the timing advance value to be applied when transmitting a PUSCH to the target NTN cell corresponds to the timing adjustment indication, where if ta0 is indicated as the targetTA value, it means that T_{TA} is 0; meg-PTAG means T_{TA} applied to the PTAG in the MCG; seg-PTAG means T_{TA} applied to the PTAG in the SCG; mcg-STAG with STAG-Id means T_{TA} applied to the STAG corresponding to STAG-Id in the MCG; seg-STAG with STAG-Id means T_{TA} applied to the STAG corresponding to STAG-Id in the SCG. In LTE, N_{TA} is considered as a timing adjustment indication, but in NR, there are other elements that make up T_{TA}, namely N_{TA, common} and N_{TA,UE-specific}, so T_{TA} should be considered rather than N_{TA}. Upon receiving the above configuration information, the UE 1k-05 recognizes the timing advance value (T_{TA}) to be applied when transmitting a PUSCH to the target NTN cell 1k-15 based on the received information (1k-75). Hence, the UE 1k-05 and the target NTN cell 1k-15 derive and have the same timing advance value.

The target NTN cell 1k-15 periodically allocates radio resources according to the preset scheduling information, taking into account the TA value derived above (1k-80). If the above scheduling information is not provided, the UE 1k-05 monitors the PDCCH of the target cell. The UE 1k-05 transmits a PUSCH at a specific time and radio resource location based on the derived TA value and the scheduling information in the target NTN cell 1k-15 (1k-85). The PUSCH includes an RRCReconfigurationComplete message. Upon successfully receiving the PUSCH, to set more accurate uplink timing, the target NTN cell 1k-15 may receive a TAR MAC CE or TAC (timing advance command) MAC CE from the UE 1k-05 (1k-90).

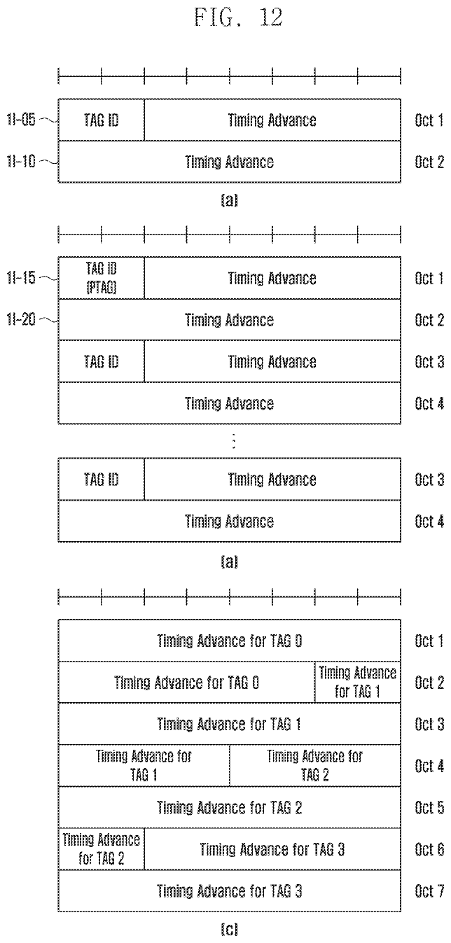

FIG. 12 is a diagram illustrating the format of a new timing advance report MAC CE according to an embodiment of the disclosure.

When supporting CA/DC in the NTN, one or more timing advance groups (TAGs) may be configured for each cell group (CG). The TAG is a set of serving cells with the same timing advance. The TAG that includes the PCell (primary cell) or the PSCell (primary secondary cell) is called a PTAG (primary TAG), and the TAG that is composed only of SCells (secondary cells) is called a STAG (secondary TAG). Up to four TAGs may be configured per CG.

In this embodiment, an improved TAR MAC CE is proposed so that the UE may report the timing advance for each TAG. There may be a form that stores a timing advance value for one TAG and a form that stores timing advance values for multiple TAGs. The UE may report capability information including an indicator indicating whether it supports the new TAR MAC CE to the base station. In addition, the base station may transmit the UE configuration information indicating that the new TAR MAC CE may be used.

The TAR MAC CE used to report the timing advance value for one TAG (part (a) of FIG. 12) is composed of 2 bits 1l-05 indicating the TAG ID and 14 bits 1l-10 indicating the TA value. Here, TAG ID 0 indicates the PCell or PSCell.

The TAR MAC CE used to report the timing advance values for multiple TAGs (part (b) of FIG. 11) may include up to four pairs, each of which is composed of 2 bits 1ₗ-15 indicating the TAG ID and 14 bits 1l-20 indicating the TA value. When composed of multiple pairs, the TA fields of the TAGs may be arranged in increasing order of corresponding TAG IDs. Alternatively, the TA field in correspondence to the PTAG may always be located first in the above TAR MAC CE.

The TA values corresponding to the four TAGs belonging to one CG may always be included, in which case the TAG ID field is unnecessary. Hence, as illustrated in part (c) of FIG. 11, the TAG ID field may be omitted, and the TA fields of the TAGs may be arranged in increasing order of corresponding TAG IDs. If a specific TAG belonging to one CG is not configured, the UE may set a random value in the TA field corresponding to the above TAG, and the base station receiving this TAR MAC CE may ignore the TA field set to a random value.

If CA/DC is introduced to the NTN, the UE may report the propagationDelay Difference value for each TAG. propagationDelayDifference reported by the UE using a UAI message is the difference between the service link propagation delay of the serving cell and the service link propagation delay of a neighbor cell. Hence, the propagationDelayDifference value may vary depending on the TAG to which the serving cell belongs. In this embodiment, the PropDelayDiffReportConfig IE may include ID information of a reference serving cell or TAG applied to derive the propagationDelayDifference value. The ID information may be provided for each entry of neighCellInfoList of the PropDelayDiffReportConfig IE. For example, the entries of the new IE storing the above ID information may correspond in order to the entries of neighCellInfoList of the PropDelayDiffReportConfig IE. Here, the UE derives the propagationDelayDifference value by using the service link propagation delay of the reference serving cell indicated above, or the service link propagation delay of one serving cell belonging to the indicated TAG. When reporting the propagationDelayDifference value, the UE may also report the following specific information.
ID of the serving cell used to derive the propagationDelayDifference value, such as CGI, PCI or serving cell index.
ID of the TAG used to derive the propagationDelayDifference value

To reduce complexity, the reference serving cell may always be fixed to the SpCell (i.e., PCell or PSCell).

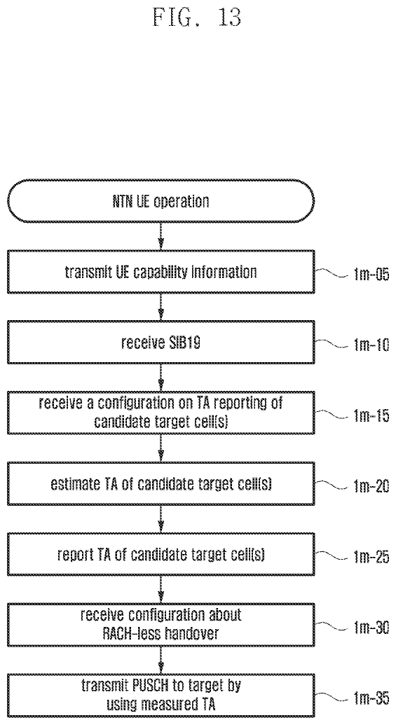

FIG. 13 is a flowchart of UE operations for performing NTN RACH-less handover according to an embodiment of the disclosure.

At step 1m-05, the UE transmits its UE capability information to the source NTN base station. This capability information includes an indicator indicating whether the UE supports RACH-less handover in the NTN environment.

At step 1m-10, the UE receives specific configuration information about the serving NTN and neighbor NTN cells through system information SIB19.

At step 1m-15, the UE receives specific configuration information, which enables obtaining TA information of neighbor NTN cells, from the source NTN base station. The TA information is T_{TA}, or T_{TA, UE-specific} (or N_{TA,UE-specific}) and T_{TA, common} (or N_{TA, common}) that constitute T_{TA}.

At step 1m-20, the UE derives TA information for a preset neighbor NTN cell through a suitable method.

At step 1m-25, the UE reports the derived TA information to the source NTN base station.

At step 1m-30, the UE receives RACH-less handover configuration information from the source NTN base station. Here, the target cell in the RACH-less handover is the neighbor NTN cell.

At step 1m-35, the UE transmits a PUSCH to the target NTN cell at a specified time by applying the derived TA.

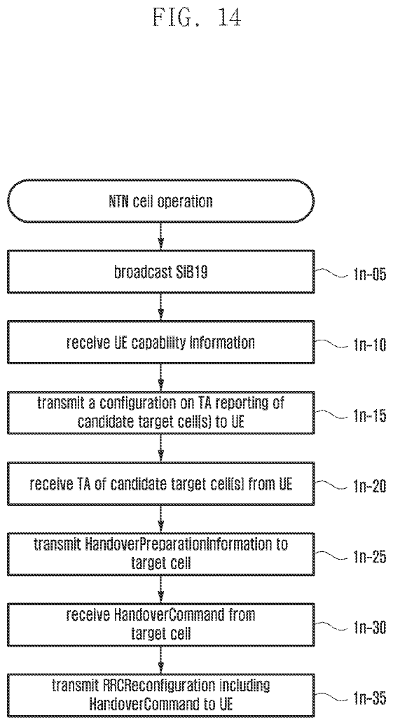

FIG. 14 is a flowchart of base station operations for performing NTN RACH-less handover according to an embodiment of the disclosure.

At step 1n-05, the base station broadcasts specific configuration information about the serving NTN and neighbor NTN cells through system information SIB19.

At step 1n-10, the base station receives UE capability information including an indicator indicating whether RACH-less is supported in the NTN environment from a UE.

At step 1n-15, the base station transmits specific configuration information to the UE to obtain TA information of a neighbor NTN cell.

At step 1n-20, the base station receives TA information of the neighbor NTN cell from the UE.

At step 1n-25, the base station transmits a HandoverPreparationInformation message including the TA information to the neighbor NTN cell.

At step 1n-30, the base station receives a HandoverCommand message from the neighbor NTN cell. HandoverCommand includes information necessary to perform RACH-less handover.

At step 1n-35, the base station transmits an RRCReconfiguration message including HandoverCommand to the UE.

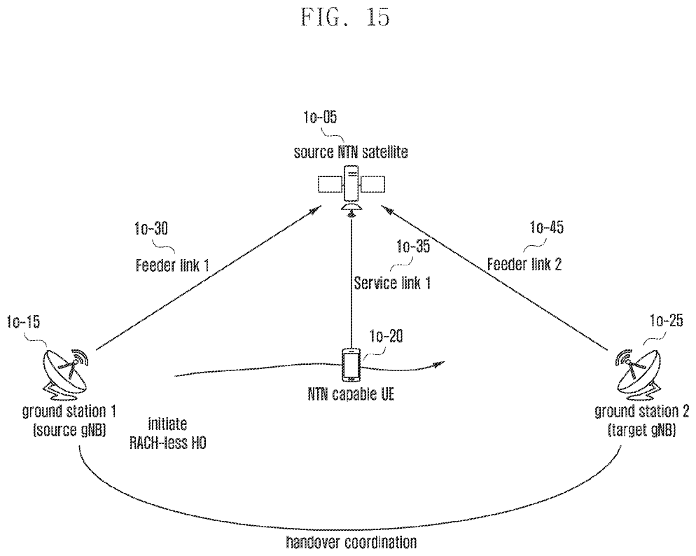

FIG. 15 is a diagram illustrating a scenario for an intra-NTN satellite to perform RACH-less handover according to an embodiment of the disclosure.

If the source ground station 1o-15 and the target ground station 1o-25 are connected to the UE 1o-20 through the same NTN satellite 1o-05, the service link propagation delays 1o-35 of the source cell and the target cell will be the same. Hence, to perform the RACH-less handover, the service link propagation delay of the source cell may be directly applied as the service propagation delay of the target cell. Therefore, in an intra-NTN scenario as described above, the process in which the UE 1o-20 reports the TA information of the target cell to the source base station 1o-15 may be omitted in the above embodiments.

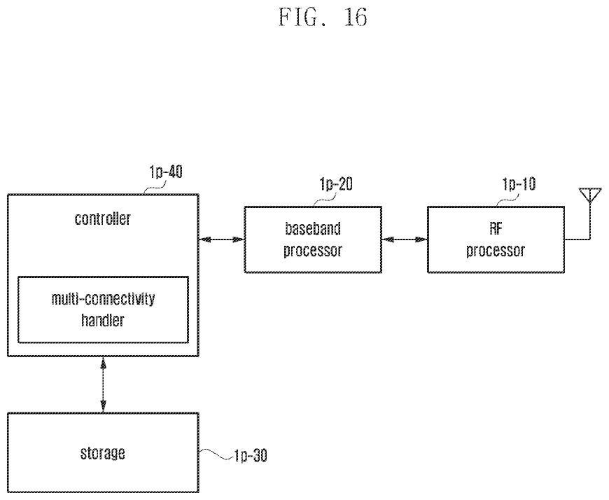

FIG. 16 is a block diagram illustrating the internal structure of a UE according to an embodiment of the disclosure.

With reference to FIG. 16, the UE may include a radio frequency (RF) processor 1p-10, a baseband processor 1p-20, a storage 1p-30, and a controller 1p-40.

The RF processor 1p-10 performs a function for transmitting and receiving a signal through a radio channel, such as signal band conversion and amplification. That is, the RF processor 1p-10 performs up-conversion of a baseband signal provided from the baseband processor 1p-20 into an RF-band signal and transmits it through an antenna, and performs down-conversion of an RF-band signal received through an antenna into a baseband signal. For example, the RF processor 1p-10 may include a transmission filter, a reception filter, an amplifier, a mixer, an oscillator, a digital-to-analog converter (DAC), and an analog-to-digital converter (ADC). Although only one antenna is illustrated in the drawing, the UE may be provided with a plurality of antennas. Also, the RF processor 1p-10 may include a plurality of RF chains. Further, the RF processor 1p-10 may perform beamforming. For beamforming, the RF processor 1p-10 may adjust phases and magnitudes of individual signals transmitted and received through the plural antennas or antenna elements. Further, the RF processor may perform MIMO, and may receive several layers during an MIMO operation.

The baseband processor 1p-20 performs conversion between a baseband signal and a bit stream in accordance with the physical layer specification of the system. For example, during data transmission, the baseband processor 1p-20 generates complex symbols by encoding and modulating a transmission bit stream. Further, during data reception, the baseband processor 1p-20 restores a reception bit stream by demodulating and decoding a baseband signal provided from the RF processor 1p-10. For example, in the case of utilizing orthogonal frequency division multiplexing (OFDM), for data transmission, the baseband processor 1p-20 generates complex symbols by encoding and modulating a transmission bit stream, maps the complex symbols to subcarriers, and composes OFDM symbols through inverse fast Fourier transform (IFFT) operation and cyclic prefix (CP) insertion. Further, for data reception, the baseband processor 1p-20 divides a baseband signal provided from the RF processor 1p-10 in units of OFDM symbols, restores the signals mapped to subcarriers through fast Fourier transform (FFT) operation, and restores the reception bit stream through demodulation and decoding. The baseband processor 1p-20 and the RF processor 1p-10 transmit and receive signals as described above. Hence, the baseband processor 1p-20 and the RF processor 1p-10 may be called a transmitter, a receiver, a transceiver, or a communication unit. Further, to support different radio access technologies, at least one of the baseband processor 1p-20 or the RF processor 1p-10 may include a plurality of communication modules. In addition, to process signals of different frequency bands, at least one of the baseband processor 1p-20 or the RF processor 1p-10 may include different communication modules. For example, the different radio access technologies may include a wireless LAN (e.g., IEEE 802.11), a cellular network (e.g., LTE), and the like. In addition, the different frequency bands may include a super high frequency (SHF) band (e.g., 2.NRHz, NRhz) and a millimeter wave (mmWave) band (e.g., 60 GHz).

The storage 1p-30 stores data such as basic programs, application programs, and configuration information for the operation of the UE. In particular, the storage 1p-30 may store information about a second access node that performs wireless communication using a second radio access technology. The storage 1p-30 provides stored data in response to a request from the controller 1p-40.

The controller 1p-40 controls the overall operation of the UE. For example, the controller 1p-40 transmits and receives signals through the baseband processor 1p-20 and the RF processor 1p-10. Further, the controller 1p-40 writes or reads data to or from the storage 1p-30. To this end, the controller 1p-40 may include at least one processor. For example, the controller 1p-40 may include a communication processor (CP) for controlling communication and an application processor (AP) for controlling higher layers such as application programs.

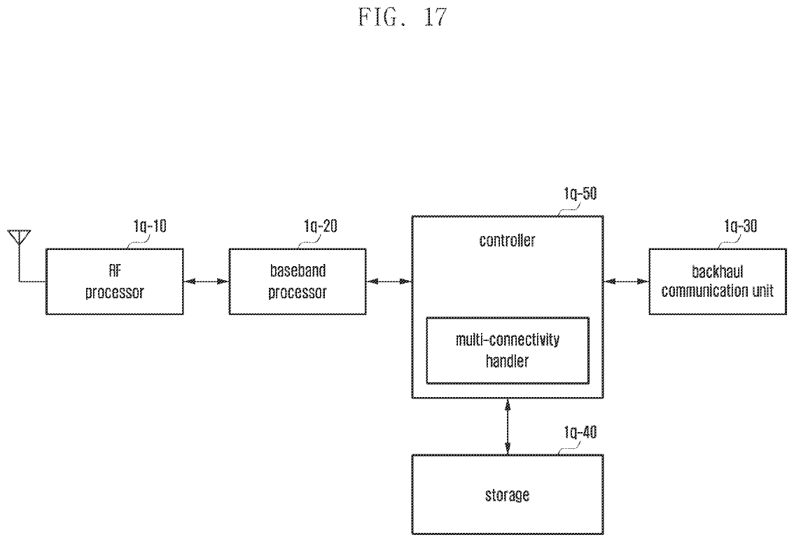

FIG. 17 is a block diagram of a base station in a wireless communication system according to an embodiment of the disclosure.

With reference to FIG. 17, the base station includes an RF processor 1q-10, a baseband processor 1q-20, a backhaul communication unit 1q-30, a storage 1q-40, and a controller 1q-50.

The RF processor 1q-10 performs a function for transmitting and receiving a signal through a radio channel, such as signal band conversion and amplification. That is, the RF processor 1q-10 performs up-conversion of a baseband signal provided from the baseband processor 1q-20 into an RF-band signal and transmits the converted signal through an antenna, and performs down-conversion of an RF-band signal received through an antenna into a baseband signal. For example, the RF processor 1q-10 may include a transmission filter, a reception filter, an amplifier, a mixer, an oscillator, a DAC, and an ADC. Although only one antenna is illustrated in the drawing, the first access node may be provided with a plurality of antennas. Additionally, the RF processor 1q-10 may include a plurality of RF chains. Further, the RF processor 1q-10 may perform beamforming. For beamforming, the RF processor 1q-10 may adjust phases and amplitudes of individual signals transmitted and received through plural antennas or antenna elements. The RF processor may perform downlink MIMO operation by transmitting one or more layers.

The baseband processor 1q-20 performs conversion between a baseband signal and a bit stream in accordance with the physical layer specification of a first radio access technology. For example, for data transmission, the baseband processor 1q-20 generates complex symbols by encoding and modulating a transmission bit stream. Further, for data reception, the baseband processor 1q-20 restores a reception bit stream by demodulating and decoding a baseband signal provided from the RF processor 1q-10. For example, in the case of utilizing OFDM, for data transmission, the baseband processor 1q-20 generates complex symbols by encoding and modulating a transmission bit stream, maps the complex symbols to subcarriers, and composes OFDM symbols through IFFT operation and CP insertion. Further, for data reception, the baseband processor 1q-20 divides a baseband signal provided from the RF processor 1q-10 in units of OFDM symbols, restores the signals mapped to subcarriers through FFT operation, and restores the reception bit stream through demodulation and decoding. The baseband processor 1q-20 and the RF processor 1q-10 transmit and receive signals as described above. Hence, the baseband processor 1q-20 and the RF processor 1q-10 may be called a transmitter, a receiver, a transceiver, a communication unit, or a wireless communication unit.

The backhaul communication unit 1q-30 provides an interface for communication with other nodes in the network. That is, the backhaul communication unit 1q-30 converts a bit stream, which is to be transmitted from the primary base station to another node, for example, a secondary base station or the core network, into a physical signal, and converts a physical signal received from another node into a bit stream.

The storage 1q-40 stores data such as basic programs, application programs, and configuration information for the operation of the primary base station. In particular, the storage 1q-40 may store information on a bearer allocated to a connected UE and measurement results reported from the connected UE. Further, the storage 1q-40 may store information used as a criterion for determining whether to provide or suspend multi-connectivity to the UE. In addition, the storage 1q-40 provides stored data in response to a request from the controller 1q-50.

The controller 1q-50 controls the overall operation of the primary base station. For example, the controller 1q-50 transmits and receives signals through the baseband processor 1q-20 and the RF processor 1q-10 or through the backhaul communication unit 1q-30. Further, the controller 1q-50 writes or reads data to or from the storage 1q-40. To this end, the controller 1q-50 may include at least one processor.

In specific embodiments of the disclosure described above, the elements included in the disclosure are expressed in a singular or plural form according to the presented specific embodiment. However, the singular or plural expression is appropriately selected for ease of description according to the presented situation, and the disclosure is not limited by a single element or plural elements. Those elements described in a plural form may be configured as a single element, and those elements described in a singular form may be configured as plural elements.

Meanwhile, the embodiments disclosed in the specification and drawings described above are only specific examples presented to easily explain the contents of the disclosure and help understanding, and are not intended to limit the scope of the disclosure. Therefore, the scope of the disclosure should be interpreted to include not only the embodiments disclosed herein but also all changes or modifications derived based on the technical idea of the disclosure.

1. A method performed by a first non-terrestrial network (NTN) base station in a wireless communication system, the method comprising:
determining a random access channel (RACH)-less handover to a second NTN base station for a terminal;
obtaining, from the second NTN base station, configuration information associated with the RACH-less handover; and
transmitting, to the terminal, a radio resource control (RRC) reconfiguration message including the configuration information and timing information applied to the second NTN base station,
wherein whether a timing adjustment value for the second NTN base station is equal to a timing adjustment value for the first NTN base station is indicated by the timing information,
wherein physical uplink shared channel (PUSCH) transmission from the terminal to the second NTN base station is performed based on the timing information and the configuration information.

2. The method of claim 1, wherein the timing information indicates the timing adjustment value for the second NTN base station as 0 or the timing adjustment value for the first NTN base station.

3. The method of claim 1, further comprising:
receiving, from the terminal, a timing advance report (TAR) on a medium access control (MAC) control element (CE); and
determining the timing information based on timing advance information for the first NTN base station and timing advance information for the second NTN base station which are included in the TAR.

4. The method of claim 1, comprising:
transmitting, to the terminal, system information including information associated with a location of the second NTN base station and information associated with a delay for a feeder link between the second NTN base station and a ground station; and
receiving, from the terminal, timing advance information for the second NTN base station,
wherein the timing advance information includes at least one of first timing advance information for a service link between the terminal and the second NTN base station or second timing advance information for the feeder link.

5. A method performed by a terminal in a wireless communication system, the method comprising:
receiving, from a first non-terrestrial network (NTN) base station, a radio resource control (RRC) reconfiguration message including configuration information associated with a random access channel (RACH)-less handover to a second NTN base station and timing information applied to the second NTN base station; and
performing physical uplink shared channel (PUSCH) transmission to the second NTN base station based on the timing information and the configuration information,
wherein whether a timing adjustment value for the second NTN base station is equal to a timing adjustment value for the first NTN base station is indicated by the timing information.

6. The method of claim 5, wherein the timing information indicates the timing adjustment value for the second NTN base station as 0 or the timing adjustment value for the first NTN base station.

7. The method of claim 5, further comprising:
obtaining timing advance information for the first NTN base station and timing advance information for the second NTN base station; and
transmitting, to the first NTN base station, a timing advance report (TAR) on a medium access control (MAC) control element (CE), the TAR including the timing advance information for the first NTN base station and the timing advance information for the second NTN base station,
wherein the timing information is based on the TAR.

8. The method of claim 5, further comprising:
receiving, from the first NTN base station, system information including information associated with a location of the second NTN base station and information associated with a delay for a feeder link between the second NTN base station and a ground station; and
transmitting, to the first NTN base station, timing advance information for the second NTN base station,
wherein the timing advance information includes at least one of first timing advance information for a service link between the terminal and the second NTN base station or second timing advance information for the feeder link.

9. A first non-terrestrial network (NTN) base station in a wireless communication system, the first NTN base station comprising:
a transceiver; and
a controller configured to:
determine a random access channel (RACH)-less handover to a second NTN base station for a terminal,
obtain, from the second NTN base station, configuration information associated with the RACH-less handover, and
control the transceiver to transmit, to the terminal, a radio resource control (RRC) reconfiguration message including the configuration information and timing information applied to the second NTN base station,
wherein whether a timing adjustment value for the second NTN base station is equal to a timing adjustment value for the first NTN base station is indicated by the timing information,
wherein physical uplink shared channel (PUSCH) transmission from the terminal to the second NTN base station is performed based on the timing information and the configuration information.

10. The first NTN base station of claim 9, wherein the timing information indicates the timing adjustment value for the second NTN base station as 0 or the timing adjustment value for the first NTN base station.

11. The first NTN base station of claim 9, wherein the controller is further configured to control the transceiver to receive, from the terminal, a timing advance report (TAR) on a medium access control (MAC) control element (CE), and determine the timing information based on timing advance information for the first NTN base station and timing advance information for the second NTN base station which are included in the TAR.

12. The first NTN base station of claim 9,
wherein the controller is further configured to control the transceiver to transmit, to the terminal, system information including information associated with a location of the second NTN base station and information associated with a delay for a feeder link between the second NTN base station and a ground station, and control the transceiver to receive, from the terminal timing advance information for the second NTN base station, and
wherein the timing advance information includes at least one of first timing advance information for a service link between the terminal and the second NTN base station or second timing advance information for the feeder link.

13. A terminal in a wireless communication system, the terminal comprising:
a transceiver; and
a controller configured to:
control the transceiver to receive, from a first non-terrestrial network (NTN) base station, a radio resource control (RRC) reconfiguration message including configuration information associated with a random access channel (RACH)-less handover to a second NTN base station and timing information applied to the second NTN base station, and
control the transceiver to perform physical uplink shared channel (PUSCH) transmission to the second NTN base station based on the timing information and the configuration information,
wherein whether a timing adjustment value for the second NTN base station is equal to a timing adjustment value for the first NTN base station is indicated by the timing information.

14. The terminal of claim 13,
wherein the controller is further configured to obtain timing advance information for the first NTN base station and timing advance information for the second NTN base station, and control the transceiver to transmit, to the first NTN base station, a timing advance report (TAR) on a medium access control (MAC) control element (CE), the TAR including the timing advance information for the first NTN base station and the timing advance information for the second NTN base station, and
wherein the timing information is based on the TAR.

15. The terminal of claim 13,
wherein the controller is further configured to control the transceiver to receive, from the first NTN base station, system information including information associated with a location of the second NTN base station and information associated with a delay for a feeder link between the second NTN base station and a ground station, and control the transceiver to transmit, to the first NTN base station, timing advance information for the second NTN base station, and
wherein the timing advance information includes at least one of first timing advance information for a service link between the terminal and the second NTN base station or second timing advance information for the feeder link.
